(19) United States
(12) Patent Application Publication
(10) Pub. No.: US 2005/0002533 A1
(43) Pub. Date: Jan. 6, 2005

(54) Fully secure message transmission over non-secure channels without cryptographic key exchange

(76) Inventors: Jerry Joe Langin-Hooper, Colorado Springs, CO (US); Kanan Joseph Langin-Hooper, Colorado Springs, CO (US)

Correspondence Address: Gould & Whitley, Suite 101, 1665 Briargate Boulevard, Colorado Springs, CO, 80920, US

(21) Appl. No.: 10/612,450

(22) Filed: Jul. 1, 2003

(51) Int. Cl. H04L 9/00

(52) U.S. Cl. 380/278

(57) ABSTRACT

A cryptographic system transmits a fully secure cryptographic message over a non-secure communication channel without prior exchange of cryptographic keys using a three-pass protocol. The transmitting agent initiating the communication embodies the message for the designated receiving agent in the composite output of two distinct transformations such that a generalized reversal of the combined transformations cannot be determined from that output. That output is transmitted as a first-pass over a non-secure channel to the receiving agent. The receiving agent generates a second composite output by transforming the received message such that a generalized reversal of this second combined transformation cannot be determined from that resulting output. That second output is transmitted as a second-pass over a non-secure channel to the initial transmitting agent. The initial agent generates a third composite output from the returned message by reversing one of the two initial transformations such that a generalized reversal of this third composite transformation cannot be determined from that resulting output. The third output is transmitted as a third-pass over a non-secure channel to the receiving agent. The receiving agent uses a reversal of the second transformation applied to the final message to extract the initial message. The transformations (or keys) used by either party need not be known by the other, making this an independent-key cryptographic process. It is technically impossible for any eavesdropping agent, even one who captures all transmissions between the transmitting and receiving agents, to directly recreate the initial message from the observed transmissions.

### BACKGROUND OF THE INVENTION

1. Field of the Invention

The present invention relates generally to cryptography and, more particularly, to the secure transmission of messages between parties using non-secure communication channels.

2. Description of the Prior Art

Cryptographic systems are widely used to ensure the privacy of messages communicated over insecure channels. Such systems prevent the extraction of information by unauthorized parties from messages transmitted over insecure channels, thus assuring the sender that a transmitted message is being read only by the intended recipient.

Two distinct classes of cryptographic methods and protocols are widely used, symmetric-key cryptography and public-key cryptography. In symmetric-key techniques, the same key and cryptographic method are used by both the encoding party for sending the message and by the receiving party for decoding the message. The security of symmetric-key protocols is based on the secrecy of the required key and the strength of the cryptographic method. The message can be properly decoded by the receiving party only if the transmitting party and the receiving party possess the identical key used for encoding the message.

For conventional public-key key techniques such as those pioneered by Diffie and Hellman, there are two keys, a public key to which anyone can gain access and with which a plaintext message is encrypted, and a private key that only the recipient possesses and with which the encrypted message is decrypted. The security of public key protocols relies on the considerable difficulty of determining the private key by analyzing the public key. Such computational difficulty is essentially inherent in most public key processes making them considerably slower than symmetric-key protocols even for the recipient who possesses the private key. Chang has devised protocols for the exchange (or simultaneous creation) of cryptographic keys similar to the broadcast-and-response processes of public-key techniques. These key exchange techniques appear to be fully secure but simply create cryptographic keys for subsequent use by other cryptographic systems; they do not allow for the direct transmission of agent-created messages.

Mechanical systems exist which are analogous to symmetric-key and public-key systems. For the symmetrical-key process, the mechanical analogy is a locked box carried between the two parties where each party has previously obtained a copy of the key that opens the box. The first, transmitting party unlocks and opens the box, places the message inside, relocks the box and sends it to the second, receiving party who then unlocks the box and removes the message. The public-key process resembles an unlocked box and open lock with a special locking-only key left in a public place. The locking-only key is available for public inspection and analysis. Any interested, transmitting party may place a message in the box, close the lock, and secure the lock with the locking-only key; only the box's recipient owner will be able to unlock the lock with a different unlocking-only key, open the box, and remove the message.

A third mechanical analogy demonstrates the processes of the claimed invention. In it, a first party places a message in a box, locks it, and sends it to the intended recipient. The recipient places a second lock on the box and returns it to the original sender. The first party then removes the first lock from the doubly locked box and sends the still singly locked box to the intended recipient a final time. The recipient then removes the second lock, opens the box, and retrieves the message. This is the essence of the so-called three-pass protocol. Neither party shares a key to the box, differentiating this process from the symmetric-key process, and the keys to the box are never available for public inspection and analysis, differentiating this process from the public-key processes. This three-pass protocol as utilized in the claimed invention represents a third distinct class of encryption techniques that could best be described as independent-key processes, since neither party possesses nor shares a key with the other party.

In the context of modern cryptography, Schneier describes the three-pass process as a public-key system and attributes the protocol to Shamir. A primary limitation of the three-pass protocol has been the ability of an eavesdropping third party to use the three transmitted encrypted messages to “crack the code” and derive the original plaintext message. Schneier demonstrates that even otherwise secure symmetric key protocols such as one-time pads are not secure in a three-pass process. Shamir (concurrently with Omura) devised an encryption algorithm for the three-pass protocol using an RSA-like factoring algorithm as the key mechanism. Others have used the three-pass protocol as well; for example, Massey devised a key mechanism based on GF(2^{m}) finite fields. Both implementations use key processes that are computationally difficult—like conventional public-key methods—but not fully secure.

The claimed invention uses the three-pass protocol and creates cryptographic processes that are fully secure while requiring no cryptographic key exchange. The processes of the invention are differentiated from the previous, public-key-like, three-pass protocols. The technique of the invention is designated as an independent-key process.

### SUMMARY AND OBJECTS OF THE INVENTION

One object of the invention is to provide a fully secure cryptographic technique for maintaining privacy of messages conveyed or transmitted over non-secure channels while requiring no exchange of any cryptographic keys, either public or private.

Accordingly, it is another object of this invention to allow two parties to the communication of a message to exchange the message privately even though another party (an eavesdropper) intercepts all of their communications.

Another object of this invention is to provide for the fully secure exchange of messages—including cryptographic keys—between two parties even when the communication is transmitted over non-secure channels.

Another object of this invention is to provide for a message exchange protocol that is fully secure against all but a brute force cryptanalysis attack.

Another object of this invention is to provide for a fully secure message exchange protocol that is faster than most, if not all, present protocols that do not require each party to share identical encryption/decryption keys.

Briefly, for two parties desiring the private communication of a plaintext message (P)—the first, transmitting party (T) and the second, receiving party (R)—three encrypted messages (C₁, C₂, and C₃) are created and communicated between the parties to generate the fully secure transmission of the initial message P.

The first party T chooses two distinct transformation processes (α and β) and key elements for those processes with characteristics such that the plaintext message P may be embodied in the output of the transformation process α, the transformation process β can be readily reversed, and the composite transformation of the operation of the transformation process β on the output of the process α embodying message P cannot be reversed. The first encrypted message C, is created as the output of the operation of the transformation process β on the output of the process α embodying P and is transmitted by the first party T over a non-secure channel to the second party R. The steps taken by the first party T in creating the first encrypted message C₁ are represented as follows:

| | |
|---|---|
| α(P) | The result of the transformation α embodies P |
| β′ exists | The transformation β can be reversed where β′ |
| | represents the reverse transformation of β |
| β(α(P))′ does not exist | The composite process of the transformation β |
| | acted on the transformation α can not be reversed |
| C₁ [symbol] β(α(P)) | The encrypted message C₁ is assigned the |
| | composite result of the transformation β acted |
| | on the transformation α |

Reversal of a transformation is taken to mean that given the specific characteristics of the transformation and a specific output of that transformation, the corresponding inputs to the transformation can be derived. Transformations that cannot be reversed are those for which even when given the specific characteristics of the transformation and a specific output of that transformation, the corresponding inputs to the transformation cannot be derived. For the purpose of the invention, transformations may include but are not limited to mathematical functions and their equivalents. For transformations consisting of mathematical functions, the process of reversing the transformations is known as inverting the functions. In general, the transformations referenced herein may exhibit a more limited or more expansive set of properties than those distinctly attributed to mathematical functions.

Upon receipt of the first encrypted message C₁, the second party R chooses a distinct transformation processes (γ) and key elements for that process with characteristics such that the transformation process γ can be readily reversed and the composite transformation of the operation of the transformation process γ on the received encrypted message C₁ cannot be reversed. The second encrypted message C₂ is created as the output of the operation of the transformation process γ on the received encrypted message C₁ and is transmitted by the second party R over a non-secure channel back to the first party T. The steps taken by the second party R in creating the second encrypted message C₂ are represented as follows:

| | |
|---|---|
| γ′ exists | The transformation γ can be reversed where γ′ |
| | represents the reverse transformation of γ |
| γ (C₁)′ does not exist | The composite result of the transformation γ |
| | acted on the first encrypted message C₁ |
| | cannot be reversed |
| C₂ [symbol] γ (C₁) | The encrypted message C₂ is assigned the |
| | composite result of the transformation γ acted |
| | on the first encrypted message C₁ |

Upon receipt of the second encrypted message C₂, the first party T reverses the second of the first two transformation processes β using the reversal process that is known to exist according to the initial choice of that transformation. The third and final encrypted message C₃ is created as the output of the operation of the reverse transformation process β′ on the received encrypted message C₂ and is transmitted by the first party T over a non-secure channel back to the second party R. The steps taken by the first party T in creating the third encrypted message C₃ are represented as follows:

| | |
|---|---|
| C₃ [symbol] β′ (C₂) | The encrypted message C₃ is assigned the |
| | composite result of the reverse transformation |
| | β′ acted on the second encrypted message C₂ |

Following the reversal transformation β′, the third encrypted message C₃ represents the composite output of the operation of the transformation process γ on the output of the process α embodying message P.

A key characteristic of the transformation processes β and γ for the protocol is the requirement of viable reverse transformations that are independent of the order of the reversal operations. That is, the composite result of the second encrypted message C₂ is the culmination of all three transformation processes α, β, and γ, and it must be the case that the transformations β and γ can be reversed and applied to C₂—in any order—to yield the sole result of the first transformation α alone. For mathematical functions, this condition is essentially equivalent to the commutative property. This key characteristic allows the operation of β on α in creating C₁ to be reversed as β′ in the creation of C₃ even though the intervening transformation of γ has been applied. The invention identifies and applies transformations that make such order-independent reversal possible.

Another constraint of the choice of the transformation process γ is that the composite transformation that is the result of the operation of the transformation process γ remaining in the output C₃ after the reversal of β has been applied to C₂ cannot be reversed.

Upon receipt of the third encrypted message C₃, the second party R reverses the transformation processes γ using the reversal process that is known to exist according to the initial choice of that transformation. Following that reverse transformation, the result is simply the output of the process α embodying message P. That is,

α(P) [symbol] γ′ (C₃),

except that this copy of α (P) is now in the possession of the second party R rather than in that of the initial party T. The second party R removes the plaintext message P from its embodiment in the output of the transformation process α to yield possession of the original message created by T. The invention identifies and applies means of embodying the message P in the output of transformation process α in a manner such that the second party R can remove the message P from that embodiment.

The processes of the invention are distinctly different from previous implementations of three-pass protocols that used complex, public-key-like computational methods to implement the encryption components of each pass. The processes of the invention are straightforward transformation methods that are fully secure and yet computationally efficient. Because the invention doesn't require either party to possess or gain any information about the other's primary encryption process, the technique of the invention is designated as an independent-key process.

An advantage of the present invention is that it is technically impossible for an eavesdropper, even knowing the transmitted quantities C₁, C₂, and C₃ and the general properties and processes of the transformations α, β, and γ, to directly determine the plaintext message P because no reverse transformations can be applied to the transmitted quantities to make that determination.

### BRIEF DESCRIPTION OF THE DRAWINGS

FIG. 1 is a block diagram depicting a cryptographic system that may be employed for fully secure transmission of a message over non-secure channels without the prior exchange of cryptographic keys, according to the invention claimed herein.

FIG. 2 is a block diagram depicting a general example of a possible embodiment of such a cryptographic system that may be employed for fully secure transmission of a message over non-secure channels without the prior exchange of cryptographic keys, according to the invention claimed herein.

FIG. 3 is a block diagram depicting a specific example of a possible embodiment of such a cryptographic system that may be employed for fully secure transmission of a message over non-secure channels without the prior exchange of cryptographic keys, according to the invention claimed herein.

### DESCRIPTION OF THE PREFERRED EMBODIMENT

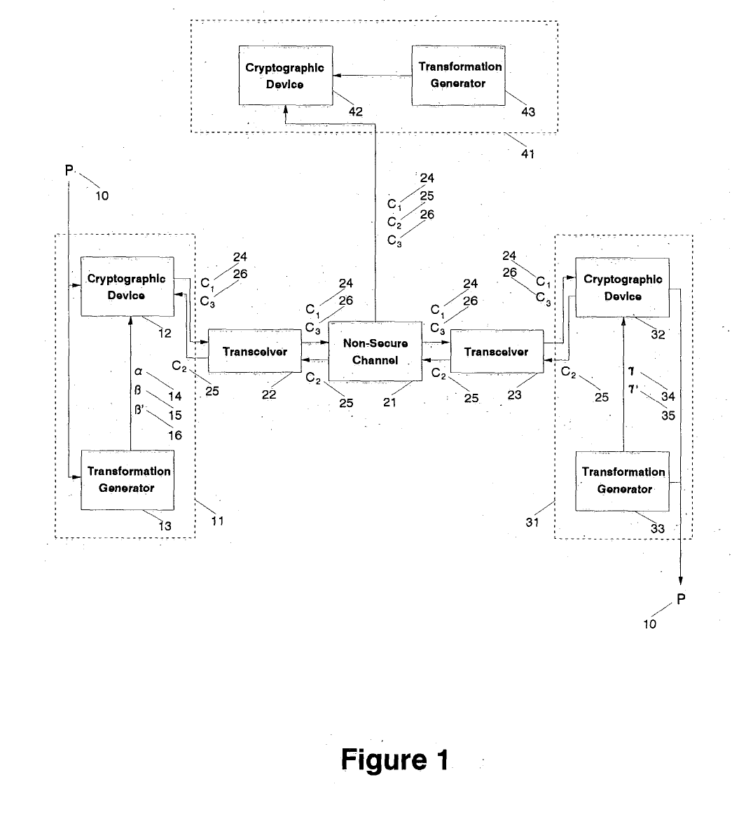

Referring to FIG. 1, a cryptographic system is shown in which all communication takes place over a non-secure channel 21. The non-secure channel 21 may include a telephone line, a radio connection, a cellular telephone connection, a fiber optic line, a microwave connection, a coaxial line, an infrared optical link, or any other communication technology that permits the transmission of information from a first location to a second location. Two-way communication is exchanged on the non-secure channel 21 between the initial converser 11 referred to as the transmitting party T and the second converser 31 referred to as the receiving party R using transceivers 22 and 23, for example digital cellular telephones, modems, or any other mechanism for converting information into the structure necessary for transmission by the non-secure channel 21. The transmitting party 11 possesses a plaintext message P 10 to be communicated to the receiving party 31.

Both the transmitting party T 11 and the receiving party R 31 use cryptographic devices 12 and 32 respectively, for encrypting and decrypting information under the action of the processes of this invention. Each cryptographic device 12 and 32 receives the output of transformation generators 13 and 33 respectively. The first transformation generator 13 creates the transformations α 14, β 15 and β′ 16 which are provided to the cryptographic device 12. The transformation β′ 16 is the reverse transformation or inversion of process β 15. The second transformation generator 33 creates the transformations γ 34 and γ′ 35 which are provided to the cryptographic device 32. The transformation γ′ 35 is the reverse transformation of γ 34.

The transmitting party T's 11 cryptographic device 12 encrypts the plaintext message P10 into the first cryptographic message C₁ 24 by transforming message P 10 through the transformations α 14 and β 15 so that no reverse transformation is possible for the resulting output C₁ 24. The first cryptographic message C₁ 24 is then transmitted through the first transceiver 22, over the non-secure channel 21, and through the second transceiver 23 to the receiving party R 31.

The receiving party R's 31 cryptographic device 32 further encrypts the received first cryptographic message C₁ 24 into the second cryptographic message C₂ 25 by transforming C₁ 24 through the transformation γ 34 so that no reverse transformation is possible for the resulting output C₂ 25. The second cryptographic message C₂ 25 is then transmitted through the second transceiver 23, back over the non-secure channel 21, and through the first transceiver 22 to the transmitting party T 11.

The transmitting party T's 11 cryptographic device 12 partially decrypts the received second cryptographic message C₂ 25 into the third cryptographic message C₃ 26 by transforming C₂ 25 through the reverse transformation β′ 16 so that no reverse transformation is possible for the resulting output C₃ 26. The third cryptographic message C₃ 26 is then transmitted through the first transceiver 22, over the non-secure channel 21, and through the second transceiver 23 to the receiving party R 31.

The receiving party R's 31 cryptographic device 32 device further decrypts the received third cryptographic message C₃ 26 by transforming C₃ 26 through the reverse transformation γ′ 35. The result now in the possession of the receiving party R 31 is the output of the process α 14 embodying P 10. The receiving party R 31 removes the plaintext message P 10 from its embodiment in the output of the transformation process α 14 to yield possession of the original message created by T 11. The receiving party R 31 does not know nor need to know the transmitting party T's 11 transformation process β 15 nor does the transmitting party T 11 know nor need to know the receiving party R's 31 transformation process γ 34. Both T 11 and R 31 know and utilize the transformation process α 14, but α 14 can be publicly known or transmitted from T 11 to R 31 without fear of interception, since the message P 10 cannot be decoded by an eavesdropper 41 who knows only transformation process α 14. Because the invention doesn't require either party to possess or gain any information about the other's primary encryption processes, the technique of the invention is designated as an independent-key process.

The cryptographic system of the invention includes a non-secure communications channel 21, making it possible for an eavesdropper 41 that is not included in the cryptographic system to receive all of the communications between the transmitting party T 11 and the receiving party R 31. The eavesdropper 41 may possess a cryptographic device 42 that includes the same processing capabilities and knowledge of the transformation processes as the cryptographic devices 12 and 32 available to the transmitting party T 11 and the receiving party R 31, and a transformation generator 43 that includes the same capabilities and available transformation processes as the transformation generators 13 and 33 available to the transmitting party T 11 and the receiving party R 31. However, even given the full content of the encrypted messages C₁ 24, C₂ 25, and C₃ 26, the eavesdropper 41 cannot directly determine or otherwise deduce the transformations α 14, β 15, or γ 34 to determine the original plaintext message P 10. The best that the eavesdropper 41 can do with the information from the messages C₁ 24, C₂ 25, and C₃ 26 is to establish some limited relationships between some of the components of the messages. However, knowledge of those relationships alone is not very informative or substantially useful to the eavesdropper 41 since the eavesdropper 41 would still have to guess the values of many specific components of the transformations. Refining that relationship information would require an amount of effort by the eavesdropper 41 no less than that required for a brute-force break of the cryptographic system. Therefore, the cryptographic system is fully secure, being no more susceptible to cryptanalytic attack than to a brute-force attack.

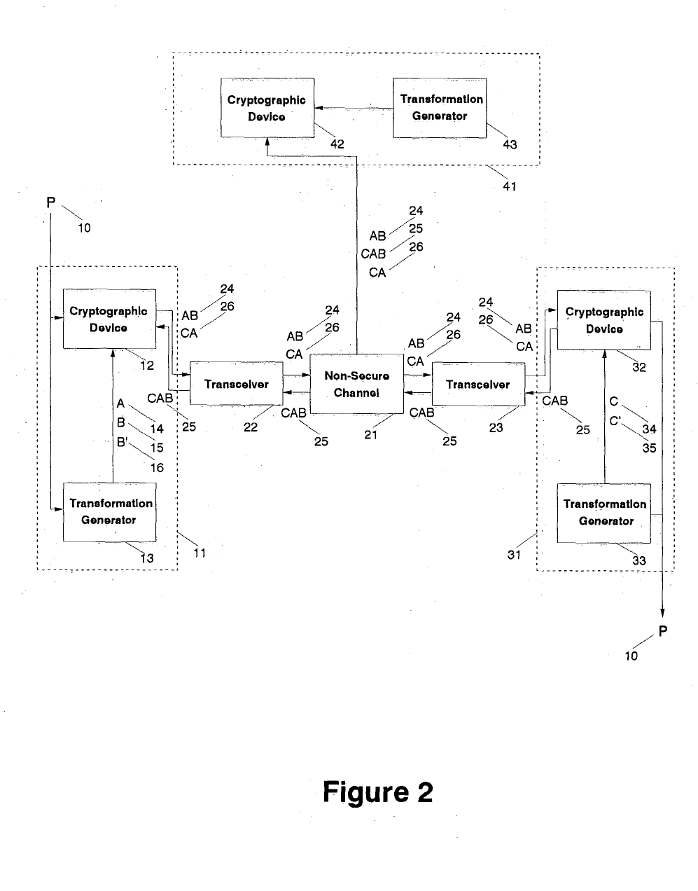

As merely a general example of a possible embodiment of the processes of this invention, the basic techniques of matrix algebra may be applied to create transformations that satisfy the requirements of the invention. This example is demonstrated in FIG. 2. As shown in FIG. 2, the transmitting party T 11 has a plaintext message P 10 to be transmitted over a non-secure channel 21 to the receiving party R 31. The transmitting party T 11 uses a transformation generator 13 to generate two transformations α 14 and β 15 such that β 15 can be reversed, but the combined transformation (α 14) (β 15) cannot be reversed. The transformation α 14 for this example is the creation of a singular (i.e., non-invertible) matrix [A] 14 where the plaintext message P 10 is embodied in the upper left block of the matrix and the remaining three blocks of the matrix are established by the transformation process to be random or quasi-random elements which exhibit characteristics such that the matrix [A] 14 cannot be inverted. The second transformation β 15 is taken to be that of post-multiplying the matrix [A] 14 by an invertible matrix [B] 15 composed of random or quasi-random elements to create the first encrypted message [AB] 24. The first encrypted message [AB] 24 which is created by the cryptographic device 12 is singular or non-invertible because one of its key components—[A] 14 (which embodies P 10)—is singular. The transmitting party T 11 transmits the matrix of elements in [AB] 24 to the receiving party R 31 over a non-secure channel 21. Upon receipt of [AB] 24, the receiving party R 31 uses the transformation generator 33 to generate the transformation γ 34 such that γ 34 can be reversed. For this example, the transformation γ 34 is taken to be the process of pre-multiplying the matrix [AB] 24 by an invertible matrix [C] 34 composed of random or quasi-random elements. Once the cryptographic device 32 is used to apply the transformation γ 34 to matrix [AB] 24, the resulting second encrypted message [CAB] 25 is also singular or non-invertible because [A] 14, a key component of that result, is singular. The receiving party R 31 transmits the matrix of elements in [CAB] 25 to the transmitting party T 11 over a non-secure channel 21. Upon receipt of [CAB] 25, the transmitting party T further transforms [CAB] 25 by post-multiplying the matrix [CAB] 25 by the inverse of the matrix [B] 15, which is [B]⁻¹ 16. That post-multiplication effectively reverses the transformation β that was the process of post-multiplying [A] 14 by [B] 15. The resulting third encrypted message [CA] 26 is also singular or non-invertible because [A] 14 is still a component of the result and is singular. The transmitting party T 11 transmits the matrix of elements in [CA] 26 to the receiving party R 31 over a non-secure channel 21. Upon receipt of [CA] 26, the receiving party R 31 further transforms [CA] 26 by pre-multiplying the matrix [CA] 26 by the inverse of the matrix [C] 34, which is [C]⁻¹ 35. That pre-multiplication effectively reverses the transformation γ 34 that was the process of pre-multiplying [AB] 24 by [C] 34. The final result of these combined transformations (implemented in this example as matrix multiplications) is the matrix [A] 14, which embodies the plaintext message P 10 in its upper left block. That result is now in the possession of the receiving party R 31. The receiving party R 31 does not know nor need to know the transmitting party T's 11 transformation matrix [B] 15 nor does the transmitting party T 11 know nor need to know the receiving party R's 31 transformation matrix [C] 34. Because the invention doesn't require either party to possess or gain any information about the other's primary encryption processes, the technique of the invention is designated as an independent-key process.

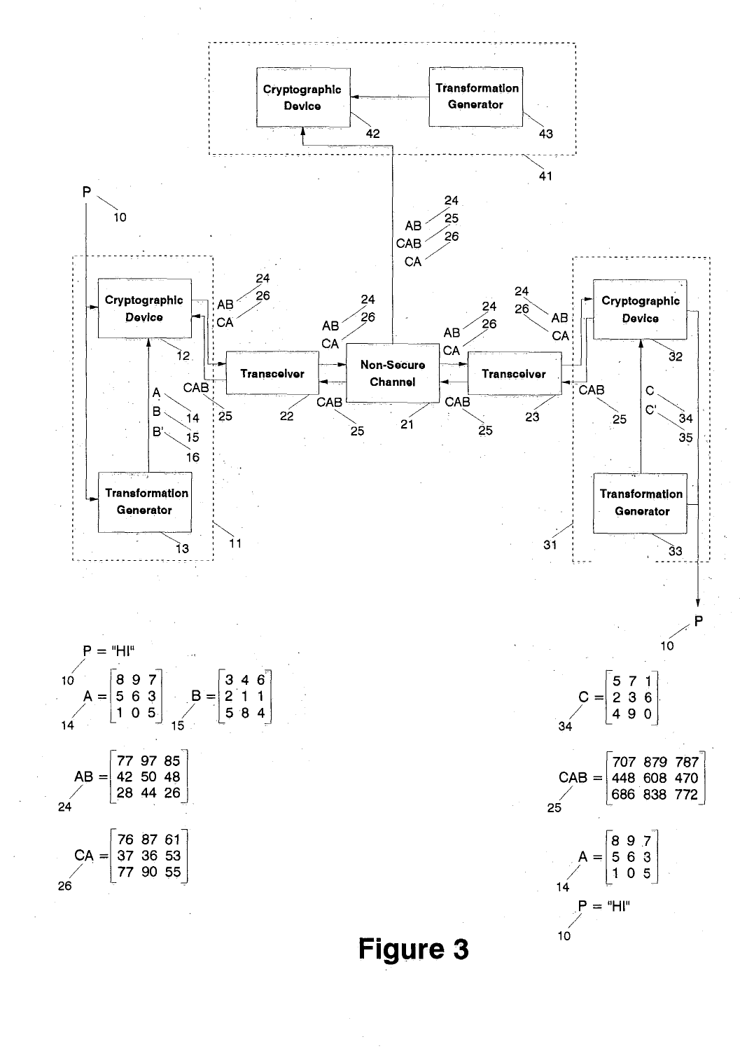

A specific example of an embodiment of the processes of this invention using the basic techniques of matrix algebra is shown in FIG. 3. As shown in FIG. 3, the transmitting party T 11 has a plaintext message P 10 of the phrase “HI” to be transmitted over a non-secure channel 21 to the receiving party R 31. The phrase “HI” is converted to a numeric equivalent of “8, 9” using the conversion of “A” to “1”, “B” to “2”, etc. Other numeric conversions of characters, such as for the standard ASCII character set, could be used. The transmitting party T 11 generates two transformations α 14 and β 15 such that β 15 can be reversed, but the combined transformation (α 14) (β 15) cannot be reversed. The transformation α 14 for this example is taken to be the creation of a singular (i.e., non-invertible) matrix [A] 14 where the plaintext message P 10 is embodied in the upper left area of the matrix and the remaining elements of the matrix are established by the transformation process to be random or quasi-random elements which exhibit characteristics such that the matrix [A] 14 cannot be inverted. The numeric equivalent “8, 9” of the message “HI” is loaded in the upper left block of [A] 14 and the remaining elements are chosen for this example to be “7, 5, 6, 3, 1, 0, 5” so that [A] 14 is non-invertible. Thus, the transformation α 14 in this example converts the message “HI” to the non-invertible matrix [A] 14. The second transformation β 15 is taken to be that of post-multiplying the matrix [A] 14 by an invertible matrix [B] 15 composed of random or quasi-random elements to create the first encrypted message [AB] 24. The matrix [B] 15 is chosen for this example to contain the elements “3, 4, 6, 2, 1, 1, 5, 8, 4” so the transformation β 15 yields the resulting elements of [AB] 24 as “77, 97, 85, 42, 50, 48, 28, 44, 26”. This first encrypted message [AB] 24 is singular or non-invertible. The transmitting party T 11 transmits the matrix of elements in [AB] 24 to the receiving party R 31 over a non-secure channel 21. Upon receipt of [AB] 24, the receiving party R 31 generates the transformation γ 34 such that γ 34 can be reversed. For this example, the transformation γ 34 is taken to be the process of pre-multiplying the matrix [AB] 24 by an invertible matrix [C] 34 composed of random or quasi-random elements. The matrix [C] 34 is chosen for this example to contain the elements “5, 7, 1, 2, 3, 6, 4, 9, 0” so the transformation γ 34 yields the resulting elements of [CAB] 25 as “707, 879, 787, 448, 608, 470, 686, 838, 772”. The resulting second encrypted message [CAB] 25 also is singular. The receiving party R 31 transmits the matrix of elements in [CAB] 25 to the transmitting party T 11 over a non-secure channel 21. Upon receipt of [CAB] 25, the transmitting party T further transforms [CAB] 25 by post-multiplying the matrix [CAB] 25 by the inverse of the matrix [B] 15, which is [B]⁻¹ 16. That post-multiplication effectively reverses the transformation β that was the process of post-multiplying [A] 14 by [B] 15. The resulting third encrypted message [CA] 26 contains the elements “76, 87, 61, 37, 36, 53, 77, 90, 55” and also is singular or non-invertible because [A] 14 is still a component of the result and is singular. The transmitting party T 11 transmits the matrix of elements in [CA] 26 to the receiving party R 31 over a non-secure channel 21. Upon receipt of [CA] 26, the receiving party R 31 further transforms [CA] 26 by pre-multiplying the matrix [CA] 26 by the inverse of the matrix [C] 34, which is [C]⁻¹ 35. That pre-multiplication effectively reverses the transformation γ 34 that was the process of pre-multiplying [AB] 24 by [C] 34. The final result of these combined transformations (implemented in this example as matrix multiplication) is the original matrix [A] 14 with the elements “8, 9, 7, 5, 6, 3, 1, 0, 5”, which embodies the plaintext message P 10 entered as “8, 9” in its upper left block. That result is now in the possession of the receiving party R 31. The receiving party R 31 does not know nor need to know the transmitting party T's 11 transformation matrix [B] 15 nor does the transmitting party T 11 know nor need to know the receiving party R's 31 transformation matrix [C] 34 in order for the plaintext message P 10 to be securely transmitted between the two.

The elements of the transformation matrices [B] 15 and [C] 34 and the non-message elements of the matrix [A] 14 can be considered “key” elements and in conjunction with the transformation processes could be labeled the “keys” to the cryptographic system of this invention.

Because the cryptographic system of the invention includes a non-secure communications channel 21, an eavesdropper 41 that is not included in the cryptographic system may receive all of the communications between the transmitting party T 11 and the receiving party R 31. The eavesdropper 41 may possess a cryptographic device 42 that includes the same processing capabilities (matrix multiplication in the case of this example) and knowledge of the transformation processes (matrix operations in the case of this example) as the cryptographic devices 12 and 32 available to the transmitting party T 11 and the receiving party R 31, and a transformation generator 43 that includes the same capabilities and available transformation processes (matrix operations in the case of this example) as the transformation generators 13 and 33 available to the transmitting party T 11 and the receiving party R 31. However, even given the full content of the encrypted messages [AB] 24, [CAB] 25, and [CA] 26, the eavesdropper 41 cannot directly determine or otherwise deduce the matrices [A] 14, [B] 15, or [C] 34 to determine the original plaintext message P 10 because the observed matrices [AB] 24, [CAB] 25, and [CA] 26 are not invertible. The best that the eavesdropper 41 can do with the information from the messages [AB] 24, [CAB] 25, and [CA] 26 is to establish some limited linear relationships between some of the elements of the message matrices. However, knowledge of those linear relationships alone is not very informative or substantially useful to the eavesdropper 41 since the eavesdropper 41 would still have to guess the values of many specific elements in the matrices. Refining that linear relationship information would require an amount of effort by the eavesdropper 41 no less than that required for a brute-force break of the cryptographic system. Therefore, the cryptographic system is fully secure, being no more susceptible to cryptanalytic attack than to a brute-force attack.

The precise encrypted messages transmitted 24, 25, 26 between transmitting party T 11 and the receiving party R 31 depend on the plaintext message P 10 and the transformation processes 14, 15, 34. The options for choices of the transformation processes 14, 15, 34 make possible nearly any observable combination of encrypted messages 24, 25, 26 regardless of the initial plaintext message P 10. The magnitude of the alternatives for observable combinations of encrypted messages is so large as to frustrate any attempt by an eavesdropper 41 to develop cryptanalytic approaches to attack the cryptographic system.

Although the present invention has been described in terms of the presently preferred embodiment, it is to be understood that such disclosure is purely illustrative and is not to be interpreted as limiting. Consequently, without departing from the spirit and scope of the invention, various alterations, modifications, and/or alternative applications of the invention will, no doubt, be suggested to those skilled in the art after having read the preceding disclosure. Accordingly, it is intended that the following claims be interpreted as encompassing all alterations, modifications, or alternative applications as fall within the true spirit and scope of the invention.

1. An apparatus for maintaining the privacy of a plaintext message transmitted over a non-secure channel between a transmitting party and a receiving party without cryptographic key exchange between said parties, comprising:
(a) first transformation means for embodying the plaintext message in a non-reversible first output;
(b) second transformation means for generating a second output which is a reversible second transformation of said first output, such that said second output is non-reversible;
(c) first transmitting means for transmitting said second output from the transmitting party to the receiving party;
(d) third transformation means for generating a third output which is a reversible third transformation of said second output, such that said third output is non-reversible;
(e) second transmitting means for transmitting said third output from the receiving party to the transmitting party;
(f) reverse second transformation means for generating a fourth output through reversal of the second transformation applied to said third output, such that said fourth output is non-reversible;
(g) third transmitting means for transmitting said fourth output from the transmitting party to the receiving party;
(h) reverse third transformation means for generating said first output through reversal of the third transformation applied to said fourth output; and
(i) extracting means for extracting the plaintext message from said first output in the possession of the receiving party.

2. An apparatus according to claim 1, wherein said first transmitting means is also said third transmitting means.

3. An apparatus according to claim 1, wherein
(a) said first transformation means comprises a first mathematical function creating an embodiment of the plaintext message in a non-invertible first output;
(b) said second transformation means comprises an invertible second mathematical function;
(c) said third transformation means comprises an invertible third mathematical function;
(d) said reverse second transformation means comprises the inverse of said second mathematical function; and
(e) said reverse third transformation means comprises the inverse of said third mathematical function.

4. A method for securely transmitting a plaintext message from a transmitting party to a receiving party over a non-secure channel, comprising the steps of:
(a) generating a first transformation of the plaintext message such that the plaintext message is embodied in a first output of said first transformation and said first output of said first transformation is non-reversible;
(b) generating a reversible second transformation of said first output of said first transformation such that a second output of said second transformation is non-reversible;
(c) transmitting said second output of said second transformation from the transmitting party to the receiving party;
(d) generating a reversible third transformation of said second output of said second transformation such that a third output of said third transformation is non-reversible;
(e) transmitting said third output of said third transformation from the receiving party to the transmitting party;
(f) reversing said second transformation on said third output of said third transformation such that a fourth output of said reversal of the second transformation is non-reversible;
(g) transmitting said fourth output of said reversal of the second transformation from the transmitting party to the receiving party;
(h) reversing said third transformation on said fourth output to yield said first output of said first transformation; and
(i) extracting the plaintext message from said first output.

5. A method according to claim 4, wherein said first transmitting means is also said third transmitting means.

6. A method according to claim 4, wherein:
(a) said first transformation comprises a first mathematical function creating an embodiment of the plaintext message in a non-invertible first output;
(b) said second transformation comprises an invertible second mathematical function;
(c) said third transformation comprises an invertible third mathematical function;
(d) said reverse second transformation comprises the inverse of said second mathematical function; and
(e) said reverse third transformation comprises the inverse of said third mathematical function.

7. An apparatus for maintaining the privacy of a plaintext message conveyed over a non-secure channel between a transmitting party and a receiving party wherein:
(a) the transmitting party neither possesses nor uses any cryptographic key that was created by the receiving party;
(b) the receiving party neither possesses nor uses any cryptographic key, that was created by the transmitting party;
(c) neither the transmitting party nor the receiving party exchanged a cryptographic key with the other party, and
(d) the plaintext message is transmitted to and understood by the receiving party, but cannot be understood by any third party who was privy to all transmissions between the transmitting party and the receiving party.

8. A method for maintaining the privacy of a plaintext message conveyed over a non-secure channel between a transmitting party and a receiving party wherein:
(a) the transmitting party neither possesses nor uses any cryptographic key, that was created by the receiving party;
(b) the receiving party neither possesses nor uses any cryptographic key, that was created by the transmitting party;
(c) neither the transmitting party nor the receiving party exchanged a cryptographic key, with the other party and
(d) the plaintext message is transmitted to and understood by the receiving party, but cannot be understood by any third party who was privy to all transmissions between the transmitting party and the receiving party.

9. An apparatus according to claim 1, wherein said plaintext message comprises a cryptographic key.

10. A method according to claim 4, wherein said plaintext message comprises a cryptographic key.
